(19) United States
(12) Patent Application Publication
(10) Pub. No.: US 2004/0217653 A1
(43) Pub. Date: Nov. 4, 2004

(54) Supply selection circuit with programmable hysteresis

(76) Inventor: Robert Alan Neidorff, Bedford, NH (US)

Correspondence Address: Dan Swayze, Texas Instruments Incorporated, M/S 3999, P.O. Box 655474, Dallas, TX, 75265, US

(21) Appl. No.: 10/425,350

(22) Filed: Apr. 29, 2003

(51) Int. Cl. H02J 1/00

(52) U.S. Cl. 307/80

(57) ABSTRACT

An apparatus (205) and system (200) for selecting between power supplies in a redundant system which can be integrated in silicon in which transistors (320, 321) are used to provide a conduction path between the power supplies and the load, and in which a comparator (305) is used to compare the voltage magnitudes of the power supplies for indicating the largest magnitude and activating the appropriate transistor (320, 321). Trip points occur when one magnitude becomes larger than the other magnitude by values determined by a programmable hysteresis of the comparator (305). The hysteresis is programmable via an external programming device which can include resistive elements (R1, R2, R3) coupled in a voltage divider arrangement. Each of the transistor switches (320, 321) can include a pair of series coupled transistor switches for use with larger hysteresis requirements.

### FIELD OF THE INVENTION

The invention relates generally to integrated circuits and, more specifically, to supply selection circuits.

### BACKGROUND OF THE INVENTION

Many different types of electrical systems offer redundant power supplies. For example, communication systems often use redundant power supplies to improve system reliability. Power supplies with multiple input voltage sources provide redundancy in the system to ensure that power continues to be provided to the system, even when one of the voltage sources fail. For selecting between the redundant supplies, selection circuits typically use diodes to allow the higher magnitude (most negative) supply to drive the load.

FIG. 1 illustrates a conventional multiple input voltage source power supply circuit used in telecommunication systems. The circuit 100 includes a first voltage source 101 coupled to a first diode 103, a second voltage source 102 coupled to a second diode 104. The cathodes of diodes 103 and 104 are coupled to the voltage sources 101 and 102, respectively, and the anodes are connected to the load 105.

In operation, when the first voltage source 101 is “ON” (i.e., supplying a voltage, such as −48V) and the second voltage source 102 is “OFF” (i.e., supplying less than −48V or not connected) then −48V is supplied to the load 105 by the first voltage source 101 because the second diode 104 is back biased. When the first voltage source 101 is “OFF” (i.e., supplying a voltage less than −48V or not connected) and the second voltage source 102 is “ON” (i.e., supplying −48V) then −48V is supplied to the load 105 by the second voltage source 102. However, power loss in each diode is significant. With larger loads, the power dissipated by these diodes is excessive. In addition, the voltage lost in these diodes reduces overall system operating margin.

Problems associated with diodes can be resolved by replacing the diodes with power MOSFETs, however, because of the difficulty in manufacturing an IC that operates from −48V, has two −48V inputs and which allows an operating variance from 0V to −100V for each supply, conventional approaches are not implemented in an integrated circuit (IC). Conventional approaches are composed with discrete transistors which are very large. Another problem associated with conventional MOSFET approaches is chattering between inputs with similar voltages caused by, for example, the voltage drop in the power distribution bus which can be very high.

Accordingly, there exists a need for a high efficiency supply selection system. The supply selection system should provide higher efficiency than conventional approaches and at the same time, provide a means for integrating with a programmable hysteresis.

### SUMMARY

The present invention achieves technical advantages as an apparatus and system for selecting between power supplies in a redundant system which can be integrated in silicon. A comparator is implemented with a programmable hysteresis selected to be less than the body diode of transistor switches used to couple the power supplies to the load in which the transistors are operated in reverse to prevent body diode conduction. The hysteretic comparator is responsive to the voltage magnitudes of the power supplies for determining the largest magnitude and for enabling switch of the power supplies to the load depending on the hysteresis. The hysteresis is programmable via an external programming device which can include resistive elements coupled in a voltage divider arrangement. Each of the transistor switches can include a pair of series coupled transistor switches for use with larger hysteresis requirements.

### BRIEF DESCRIPTION OF THE DRAWINGS

For a more complete understanding of the present invention, reference is made to the following detailed description taken in conjunction with the accompanying drawings wherein:

FIG. 1 illustrates a prior art redundant supply circuit;

FIG. 2 illustrates a redundant supply system in accordance with exemplary embodiments of the present invention;

FIGS. 3A and 3B illustrates a selection circuit for a redundant supply system in accordance with exemplary embodiments of the present invention;

FIG. 4 illustrates an integrated circuit implementation of a supply selection circuit according to exemplary embodiments of the present invention; and

FIGS. 5A and 5B show the supply selection IC of FIG. 4 illustrating a single transistor switch arrangement and a dual transistor switch arrangement.

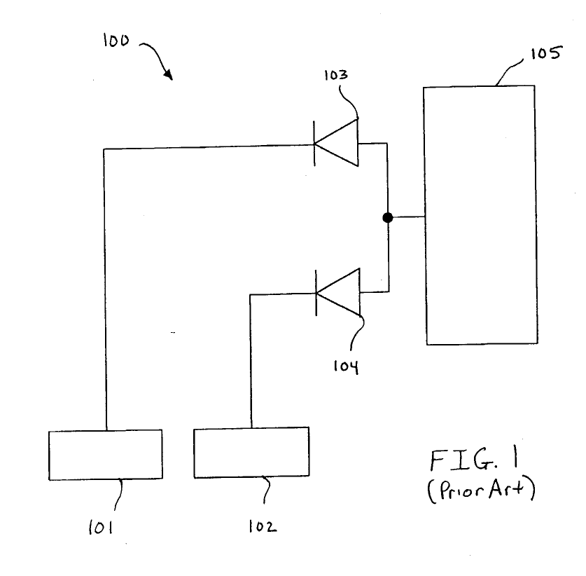

### DETAILED DESCRIPTION

The numerous innovative teachings of the present application will be described with particular reference to the presently preferred exemplary embodiments. However, it should be understood that this class of embodiments provides only a few examples of the many advantageous uses and innovative teachings herein. In general, statements made in the specification of the present application do not necessarily delimit any of the various claimed inventions. Moreover, some statements may apply to some inventive features, but not to others. Throughout the drawings, it is noted that the same reference numerals or letters will be used to designate like or equivalent elements having the same function. Detailed descriptions of known functions and constructions unnecessarily obscuring the subject matter of the present invention have been omitted for clarity.

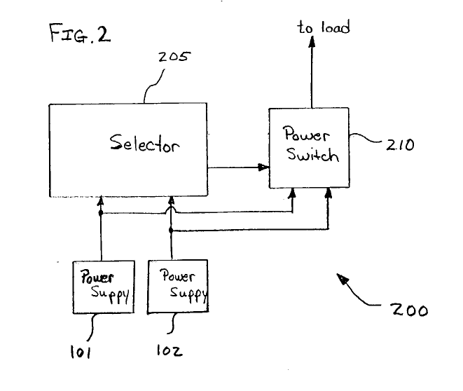

Referring now to FIG. 2 there is illustrated a dual source power system in accordance with exemplary embodiments of the present invention in which a selector 205 connects a load 105 to one of two power supplies 101 and 102 (hereinafter referred to as −V_{INA} and −V_{INB}, respectively) through a power switch 210. The selector 205 is implemented in silicon. Each of −V_{INA} and −V_{INB} are coupled to the selector 205 and the power switch 210. The selector 205 compares −V_{INA} and −V_{INB} for determining which has the highest magnitude (most negative) and signals the power switch 210 to connect the load to the determined supply. To prevent oscillation between supplies which are very close in magnitude, the selector includes a predetermined hysteresis. Although the present invention is described in terms of negative supplies, it is to be recognized that the implementation can be adapted for selection between positive supplies.

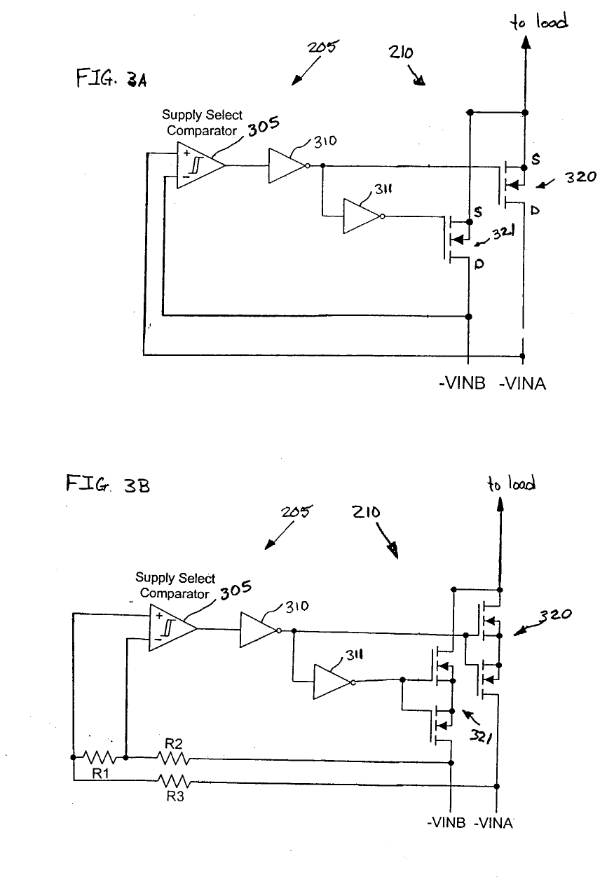

Referring now to FIG. 3A and 3B there are illustrated circuits for implementing the selector 205 and power switch 210 of FIG. 2. In FIG. 3A, a comparator 305 selects between −V_{INA} and −V_{INB} based on which supply has a larger magnitude and signals power switches 320 and 321 to operatively couple −V_{INA} and 31 V_{INB} to the load. The comparator 305 can be implemented using known circuit techniques. Switches 320 and 321 are implemented with power MOSFETs used as low voltage drop diodes. This minimizes system power dissipation over conventional diode approaches and also minimizes voltage drop through the power management chain.

Power supply −V_{INA} is connected to a first input of the comparator 305 and −V_{INB} is connected to second input. The comparator output is coupled to the input of a first inverter 310 for enabling a high signal indicative of −V_{INA} having a larger magnitude in which the output of inverter 310 is coupled with the gate of switch 320. The output of inverter 310 is further coupled with the input of a second inverter 311 for enabling a high signal indicative of −V_{INB} having a larger magnitude in which the output of inverter 311 is coupled with the gate of switch 321. The drain terminal of MOSFET switch 320 is connected to the −V_{INA} and the drain terminal of MOSFET switch 321 is connected to the −V_{INB}. Their respective source terminals are coupled with the load. It should be appreciated that MOSFET switches 320 and 321 are connected in a manner that is opposite to the conventional manner of connecting MOSFETs to enable the body diode to prevent disadvantageous conduction when the MOSFET is turned OFF.

To prevent chattering between two nearly identical supplies and to prevent supply noise or ripple from tripping the comparator 305, the comparator 305 is configured with a hysteresis which is just less than the voltage drop of a MOSFET body diode such that a voltage “trip point” occurs if the lower voltage supply magnitude becomes larger by at least the hysteresis voltage. The hysteresis should also be large enough to give the highest noise margin without allowing conduction in the body diodes of the supply selection FETs. The hysteretic comparator 305 can be implemented in an integrated circuit using known circuit techniques. For many telecommunication systems the redundant supplies −V_{INA} and −V_{INB} are −48V sources in which case a hysteresis of approximately 400 mV is preferred.

However, for communication systems with many cards, high current cards, or long cables between the power and the load, the voltage loss in the cable can be exceedingly large. If the supplies are close to the same magnitude, then the voltage loss in the cable could cause enough drop to exceed the supply selection comparator hysteresis of 400 mV. In this case, the supply selection comparator hysteresis should be increased.

In FIG. 3B, the hysteresis of the supply selection comparator is programmable via a resistive voltage divider which does not require stacked high voltage ESD diodes on the input of the IC. This embodiment shows a system with an increased hysteresis, set by R1, R2, and R3. For example, where R1=100 kΩ, R2=200 kΩ, and R3=200 kΩ, hysteresis is 2V.

In embodiments where a higher hysteresis is implemented, two MOSFETs should be used for each switch, configured in inverse series, to prevent body diode conduction. For example, if the supplies are very close to each other and voltage drop causes one supply to fluctuate +/−1V (for example) of the second, it would be preferred to declare this a small fluctuation and continue to operate from the same supply, rather than have unnecessary chatter between supplies. Unfortunately, the “unconventional configuration” described previously has the MOSFET body diode such that it will conduct if one supply gets more negative than the other by more than a diode drop (approx. 0.6V). With two FETs in back-to-back series connection as shown in FIG. 3B, body diode conduction is blocked. Even with dual FETs, the comparator output signals are still able to switch the power switches without additional drive or logic circuits.

The resistors R1, R2, and R3 can be integrated with the comparator 205 or coupled externally. However, having resistors R1, R2, and R3 external to the comparator 205 enables one IC to be manufactured with a particular hysteresis (such as 400 mV) and used for low hysteresis, low power systems and also for higher power systems that require a higher hysteresis.

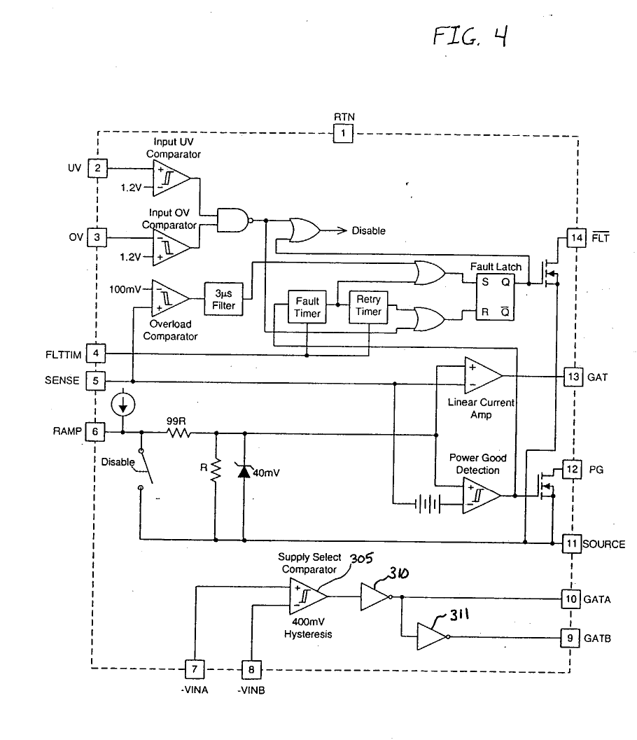

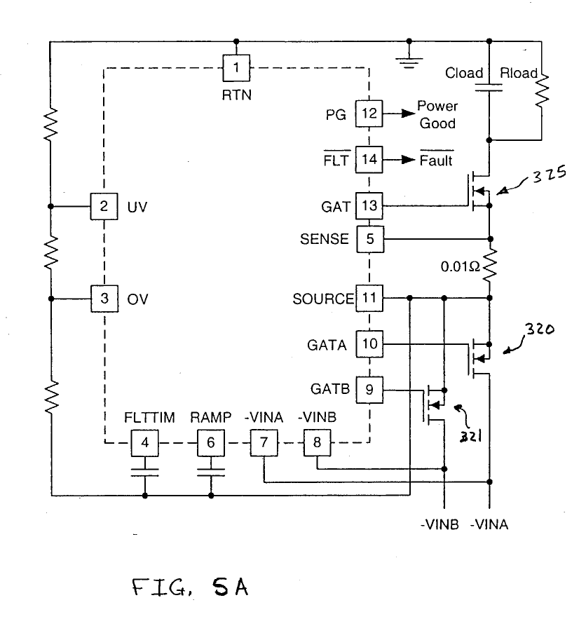

Referring now to FIG. 4 there is illustrated an integrated circuit implementation of a supply selection circuit according to exemplary embodiments of the present invention. Note the −V_{INA} and −V_{INB} supplies are input at pins 7 and 8 respectively and the corresponding outputs of the selection comparator 305 are output to pins 9 and 10. Thus, a user can program the hysteresis by connecting the above-described voltage divider to only two pins of the IC. It should be appreciated that the IC substrate is connected to terminal SOURCE, not either of the −V_{IN} pins. If the substrate is not connected to the lowest potential of the IC, then the internal parasitic diode of the IC will turn on and the IC can be damaged and/or latch-up. This parasitic diode is very similar to the parasitic diode in the MOSFET, but because of the inherent complexity of ICs, turning on this diode can cause latch-up and a conduction current can cause permanent damage. Since the substrate of an IC must be connected to the most negative input and it is not known which −Vin will be most negative at any time, an additional circuit is needed in the IC to drive the substrate based on one −Vin or the other. However in accordance with exemplary embodiments of the present invention, the comparator 305 in the IC and the two external power MOSFETs 320 and 321 can be used to accomplish this task, so the connection of the substrate to the SOURCE saves circuitry.

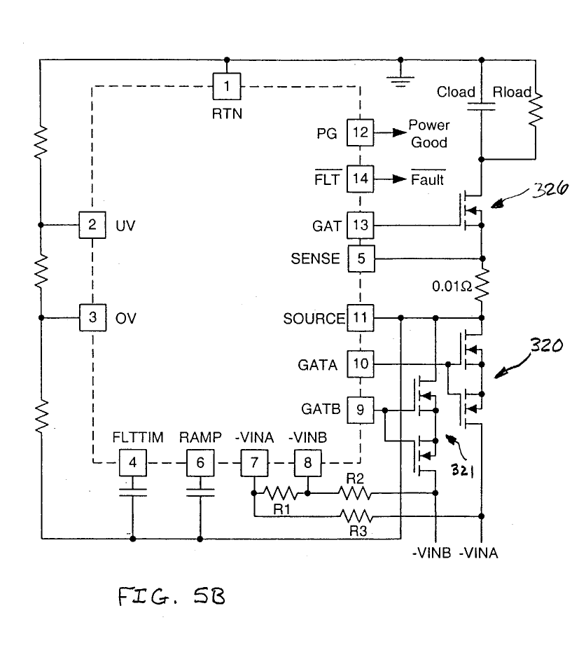

Referring now to FIGS. 5A and 5B there are shown the supply selection IC illustrating the single transistor switch arrangement and the dual transistor switch arrangement, respectively. The supply selector comparator 305 turns on the appropriate power transistor switch 320 and 321 (via output gate signals GATA and GATB) and connects the IC substrate (via Source pin 11) to the more negative of the redundant power supplies −V_{INA} and −V_{INB}. The drive signal for switch 320 is the GATA output which is coupled to the gate of the transistor for selection of the first supply −V_{INA}. Thus, when −V_{INA} is more negative than −V_{INB}, GATA is pulled 14V above −V_{INA}, turning on the transistor of switch 320. When −V_{INB} is more negative than −V_{INA}, GATA is pulled down to −V_{INB}, turning the transistor off.

The drive signal for switch 321 is the GATB output which coupled to the gate of a second transistor for selection of the second supply −V_{INB}. Thus, when −V_{INB} is more negative than −V_{INA}, GATB is pulled 14V above −V_{INB}, turning on the second transistor. When −V_{INA} is more negative than −V_{INB}, GATB is pulled down to −V_{INA}, turning the second transistor off.

Redundant supplies are used to provide high total system reliability. In the event that a component in one power supply fails, disrupting power from that supply, the defective supply should be disconnected from the load and a replacement supply should be connected. During the short interval of replacement, the load will continue to operate from the charge stored in the load capacitor (Cload).

If both supplies are directly connected to the load at the same time and one supply is defective, then the good power supply will be connected to the defective supply. Depending on the failure mechanism, in some cases, this can cause damage to the good supply, so it is important that supply switching prevent this. One way to approach this is to build the selection circuit such that switch turn-off happens quickly, yet switch turn-on happens more slowly. Another way to approach this is to monitor the output voltage and prevent switch turn-on until the output voltage drops below a predetermined level.

When transistors with body diodes are used to select between supplies, the body diode does not conduct, because the switch associated with the largest supply is always on, and that switch shunts the body diode that would have been on. If there is a need to turn on the entire supply system for any reason, such as to accommodate load board replacement, to disconnect a faulty load, or to restart a system after shutdown, the supply transistors 320 and 321 can't be used as load control, because the body diode will override any switch regulation. If soft turn-on or complete disconnect is required, a third transistor 325 can be used in series with the load as shown in FIG. 5A. This transistor is connected conventionally so that, when the transistor is off or partially on, the body diode will not conduct. Transistor 325 serves the functions of “soft turn-on control” and “fault disconnection”. Control for transistor 325 can be integrated into the same IC as the control for the supply selection transistors 320 and 321.

A similar transistor 326 can be added to the four-transistor system as shown in FIG. 5B. This can be controlled in the same way as the previously mentioned transistor 325 to implement soft turn-on and fault disconnection with the same integrated circuit.

Although exemplary embodiments of the invention are described above in detail, this does not limit the scope of the invention, which can be practiced in a variety of embodiments.

What is claimed:

1. A device for selectively coupling power supplies with a load in a plurality supply system having a first power supply and a second power supply, said device comprising:
a selector circuit comprising:
a first input for receiving from said first power supply a signal indicative of a voltage magnitude of said first power supply;
a second input for receiving from said second power supply a signal indicative of a voltage magnitude of said second power supply; and
a comparator having a programmable hysteresis and coupled to said inputs and responsive to said voltage magnitude signals indicating a first control signal for determining that said first voltage magnitude is larger than said second voltage magnitude and responsive to said voltage magnitude signals indicating a second control signal for determining that said second voltage magnitude is larger than said second voltage magnitude corresponding to said hysteresis;
a first switch responsive to said first control signal for coupling said first power supply with said load; and
a second switch responsive to said second control signal for coupling said second power supply with said load.

2. The device of claim 1, wherein said first switch is a transistor having a drain connected to said first power supply, a source coupled with said load, and a gate coupled with an output of said selector circuit for receiving said first control signal and responsive thereto for enabling a conduction path between said first power supply and said load via said drain and said source, and said second switch is a transistor having a drain connected to said second power supply, a source coupled with said load, and a gate coupled with a further output of said selector circuit for receiving said second control signal and responsive thereto for enabling a conduction path between said second power supply and said load via said second transistor drain and source.

3. The device of claim 1, wherein said first switch includes a first pair of transistors coupled in inverse series between said first power supply and said load such that a gate of each of said first transistor pair is coupled with an output of said selector circuit for receiving said first control signal and responsive thereto for enabling a conduction path between said first power supply and said load, and said second switch including a second pair of transistors coupled in inverse series between said second power supply and said load such that a gate of each of said second transistor pair is coupled with a further output of said selector circuit for receiving said second control signal and responsive thereto for enabling a conduction path between said second power supply and said load.

4. The device of claim 1, wherein said switches are operable for turn-off more quickly than for turn-on.

5. The device of claim 1 further including a transistor coupled in series between said switches and the load and operable for soft turn-on control and fault disconnection such that when said transistor is one of OFF and partially ON the body diode is non-conductive.

6. The device of claim 1, wherein said first switch and said second switch are metal oxide semiconductor field effect transistors (MOSFET).

7. The device of claim 6, wherein said first MOSFET has an integral diode which is forwardly biased from said first power supply to said load, and said second MOSFET has an integral diode which is forwardly biased from said second power supply to said load.

8. The device of claim 7, wherein said hysteresis is less than the voltage drop of said integral diodes.

9. The device of claim 1, wherein said selector circuit is integrated in a silicon chip, said first and second inputs comprise first and second external I/O pins of said integrated circuit.

10. The device of claim 9, wherein the substrate of said integrated circuit is connectable with said first power supply via a third I/O pin responsive to said first control signal from said first switch and with said second power supply via said third I/O pin responsive to said second control signal from said second switch.

11. The device of claim 1 further including a programming unit connected between said selector circuit and said power supplies for programming said hysteresis.

12. The device of claim 11 wherein said programming unit comprises:
a first resistor connected between said selector circuit first input and said first power supply;
a second resistor connected between said selector circuit second input and said second power supply; and
a third resistor connected between said first input and said second input, said resistors having selectable resistance cooperable for programming said hysteresis.

13. An apparatus for selectively coupling one of a plurality of power supplies with a load via a power switch, said apparatus comprising:
a plurality of inputs for receiving respective signals indicative of a voltage magnitude of a corresponding power supply;
a comparator having a programmable hysteresis and coupled to said inputs and responsive to said voltage magnitude signals indicating respective control signals for determining that one voltage magnitude is larger than other voltage magnitudes; and
an output providing said control signals to said power switch for enabling coupling of said load with a respective power supply responsive to a corresponding control signal indicating a larger magnitude.

14. The apparatus of claim 13 in a silicon chip, each of said inputs comprise an external I/O pin of said integrated circuit.

15. The apparatus of claim 14, wherein the substrate of said integrated chip is connectable with a respective power supply responsive to a corresponding control signal via said power switch.

16. The apparatus of claim 13 further including a programming unit comprising a voltage divider connected to said inputs between said comparator and said power supplies for programming said hysteresis.

17. The apparatus of claim 16 wherein said voltage divider comprises:
a resistive element connectable between respective inputs and power supplies; and
a further resistive element connectable between said inputs, said resistive elements having selectable resistance cooperable for programming said hysteresis.

18. The apparatus of claim 13, wherein said hysteresis is less than a body diode of a metal oxide semi conductor field effect transistor.

19. A method for selecting between power supplies in a system having a plurality of power supplies for driving a load, comprising:
using respective transistors to provide a conduction path between each of said power supplies and said load;
comparing a voltage magnitude of each of said power supplies for indicating the largest magnitude;
activating a corresponding transistor for an indication that said power supply magnitude is larger than other power supply magnitudes, wherein activating trip points occur when one magnitude becomes larger than the other magnitudes by values determined by a programmable hysteresis.

20. The method of claim 19 further including programming said hysteresis to be less than a voltage drop of the integral diode of said transistors.

21. The method of claim 19, wherein said transistors are metal oxide semiconductor field effect transistors.

22. The method of claim 19, wherein said comparing and said activating are implemented in a integrated chip, and said programming is implemented in a voltage divider circuit coupled between said power supplies and said integrated chip.
